(19) United States
(12) Patent Application Publication
(10) Pub. No.: US 2026/0341877 A1
(43) Pub. Date: Oct. 29, 2026

(54) SAFETY-FOCUSED OUTDOOR BATTERY STORAGE AND POWER CONVERSION CABINET SYSTEM

(71) Applicant: Kenneth Brison Klein, Montrose, CO (US)

(72) Inventor: Kenneth Brison Klein, Montrose, CO (US)

(73) Assignee: Kenneth Brison Klein, Montrose, CO (US)

(21) Appl. No.: 19/653,271

(22) Filed: Apr. 21, 2026

Related U.S. Application Data
(60) Provisional application No. 63/795,111, filed on Apr. 25, 2025.

(51) Int. Cl. H01M 50/251; H01M 10/6563; H01M 10/658; H01M 50/24; H01M 50/30

(52) U.S. Cl. CPC H01M 50/251; H01M 10/6563; H01M 10/658; H01M 50/24; H01M 50/30; H01M 2220/10

(57) ABSTRACT

An outdoor energy storage enclosure system employing a multi-layer wall assembly as the primary mechanism for thermal regulation, fire resistance, and moisture management. The multi-layer wall assembly comprises mineral wool insulation, fire-resistant fiber cement sheathing, a fire-retardant vapor barrier, rainscreen furring strips defining a drainage and ventilation gap, and exterior fiber cement siding, creating a non-combustible building-grade envelope adapted for energy storage. A roof assembly incorporates a vented air gap that cooperates with the rainscreen ventilation gap to form a dual-convective thermal dissipation system reducing solar heat gain. The enclosure physically separates a battery compartment from an inverter compartment via an insulated partition with no shared airflow, preventing thermal cross-contamination. Passive ventilation provides direct-to-atmosphere gas venting through a path isolated from wall cavities. Supplemental active thermal management includes a heater and thermostat-controlled fans operating within a passive-first hierarchy. A base structure provides integrated conduit routing for concealed electrical connections and forklift pockets for transport. The enclosure creates an indoor-equivalent environment enabling safe outdoor deployment of indoor-rated battery equipment.

### CROSS-REFERENCE TO RELATED APPLICATIONS

This application claims the benefit of and priority to U.S. Provisional Patent Application No. 63/795,111, filed Apr. 25, 2025, entitled “Safety-Focused Outdoor Battery Storage and Power Conversion Cabinet System,” the entire disclosure of which is incorporated herein by reference.

### TECHNICAL FIELD

The present invention relates generally to outdoor enclosures for electrical energy storage and power conversion equipment, and more particularly to a high-performance, fire-resistant, thermally managed cabinet system employing a multi-layer wall assembly, separated battery and inverter compartments, and passive thermal regulation features adapted for safe outdoor housing of battery energy storage systems.

### BACKGROUND OF THE INVENTION

The rapid expansion of distributed renewable energy generation, particularly residential and commercial rooftop solar photovoltaic systems, has created a corresponding demand for local battery energy storage. Battery energy storage systems (BESS) allow end users to store surplus energy generated during peak solar production for later consumption during evening hours, grid outages, or periods of high utility rates. As the installed base of residential solar grows and utility rate structures increasingly incentivize self-consumption, reliable and safe battery storage has become a critical infrastructure component for grid-connected and off-grid installations alike.

A primary concern with current battery storage installations is the inherent fire safety risk associated with lithium-based battery chemistries. Lithium-ion batteries are susceptible to thermal runaway, a self-reinforcing exothermic reaction that can produce extreme temperatures, flammable gases, and toxic fumes. Once thermal runaway initiates, extinguishment may require thousands of gallons of water or specialized chemical suppression agents. These fire risks are particularly acute in residential settings where battery systems are often installed in garages, utility closets, or along exterior walls in close proximity to living spaces and combustible building materials.

Regulatory frameworks including UL 9540 (Standard for Energy Storage Systems and Equipment) and UL 9540A (Test Method for Evaluating Thermal Runaway Fire Propagation in Battery Energy Storage Systems) impose stringent requirements on the design, testing, and installation of battery energy storage systems. Fire departments and local authorities having jurisdiction (AHJs) frequently mandate minimum separation distances between battery installations and occupied structures, restrict indoor installation locations, and require fire suppression infrastructure. These requirements constrain placement options and increase installation complexity and cost, particularly for residential deployments where available space is limited.

Temperature management presents a persistent challenge for outdoor battery storage. Most lithium-based batteries have optimal operating temperature ranges of approximately 60 to 80 degrees Fahrenheit, with degraded performance, reduced capacity, and shortened cycle life occurring when batteries are exposed to temperatures outside this range. Outdoor installations face extreme temperature swings, from sub-freezing winter conditions to summer ambient temperatures exceeding 100 degrees Fahrenheit, compounded by direct solar radiation on enclosure surfaces. Existing outdoor enclosures typically rely heavily on active heating, ventilation, and air conditioning (HVAC) systems to maintain acceptable internal temperatures, consuming significant parasitic energy and introducing additional points of mechanical failure.

Moisture ingress represents another critical failure mode for outdoor battery enclosures. Water intrusion can cause electrical short circuits, accelerate corrosion of electrical connections and bus bars, degrade insulation systems, and compromise the integrity of battery management electronics. Condensation within enclosures subjected to diurnal temperature cycling presents a particularly insidious risk, as moisture can accumulate gradually within wall cavities and around electrical components without visible external indication. Existing enclosure designs often employ simple gasket seals or single-layer weatherproofing that provides inadequate long-term moisture management, particularly in humid climates or installations exposed to wind-driven rain.

Current outdoor battery enclosure designs are generally derived from industrial electrical cabinet or telecommunications shelter paradigms. These designs typically employ single-wall steel or aluminum construction with minimal insulation, offering poor thermal performance and limited fire resistance. Shipping container conversions, another common approach for larger installations, suffer from similar deficiencies: thin-wall steel construction provides negligible thermal buffering, and retrofitted insulation systems frequently create condensation problems at thermal bridges. Neither approach leverages the principles of high-performance building envelope design, including continuous insulation, vapor management, and drained-and-ventilated rainscreen cladding, that have been extensively validated in the building construction industry for managing thermal loads and moisture in exterior wall assemblies.

Grid-scale containerized battery energy storage systems, typically housed within modified shipping containers or purpose-built industrial steel enclosures, represent one category of existing solutions that fails to address the residential deployment challenge. These systems are designed for utility yards, substations, and fenced industrial sites, and rely on active liquid cooling systems using refrigerants or glycol loops to manage internal temperatures. Their single-wall steel construction conducts solar heat directly into the interior, requiring continuous active cooling that consumes substantial parasitic energy. Their large physical footprints, industrial aesthetic, and reliance on complex mechanical cooling infrastructure render them unsuitable for residential lots where space is constrained, aesthetic integration is valued, and homeowners lack the expertise to maintain industrial cooling systems. Furthermore, the deflagration vents and fire suppression systems employed in these containers are designed for setback distances that are incompatible with zero-clearance residential installation.

A second category of existing solutions comprises compact residential battery cabinets that house battery modules and, in some cases, integrated inverters within single-wall metallic enclosures. These appliance-style units typically employ sheet steel or aluminum construction with intake filters and exhaust vents for basic thermal management. While sized for residential deployment, these single-wall cabinets provide negligible fire containment capability: the thin metallic shell offers minimal thermal resistance, allowing heat from an internal thermal runaway event to rapidly transfer to adjacent structures. The metal shell also conducts ambient solar heat directly into the battery compartment, increasing the duty cycle of internal fans or requiring installation in shaded locations. These cabinets lack the multi-stage thermal buffering needed to decouple the internal battery environment from extreme outdoor temperature swings, resulting in accelerated battery degradation and increased reliance on active climate control.

A third category of existing solutions includes double-walled outdoor enclosures and sandwich-panel constructions used in telecommunications and power equipment shelters. These enclosures improve upon single-wall designs by incorporating an insulating layer, typically foam-based materials such as expanded polystyrene or polyurethane, between inner and outer metal skins. However, foam-based insulations are themselves combustible and can contribute to fuel load during a battery fire, potentially accelerating rather than containing a thermal event. Moreover, double-walled metallic enclosures with simple air gaps between the skins lack the capillary break, drainage, and ventilation functions of a true rainscreen assembly, leaving them susceptible to condensation accumulation within the wall cavity and offering no mechanism to dissipate solar heat absorbed by the outer skin before it conducts inward to the battery compartment.

Current industry practice for integrated battery and inverter enclosures typically employs a centralized cooling approach in which a single HVAC unit or liquid cooling system manages the thermal environment of the entire enclosure. This approach introduces a fundamental thermodynamic conflict: the power conversion equipment (inverter) generates substantial waste heat during operation, while the battery modules require a tightly controlled, cooler environment for optimal performance and longevity. When these components share a common air volume or cooling loop, inverter waste heat migrates into the battery compartment, increasing the cooling load and subjecting batteries to temperature fluctuations driven by inverter duty cycles rather than ambient conditions. Standard NEMA-rated enclosures that provide separate compartments typically use thin metallic divider walls without insulation, which conduct heat between compartments rather than isolating them thermally. The absence of a truly non-communicating thermal boundary between heat-generating and temperature-sensitive components represents a persistent deficiency in existing integrated enclosure designs.

Various approaches to mitigating solar heat gain on outdoor enclosures have been proposed, including bolt-on solar shields, reflective coatings, and external canopies mounted above the enclosure roof. These approaches treat solar heat gain as an external problem to be deflected rather than as a component of an integrated thermal management strategy. Bolt-on shields create an air gap above the enclosure roof but are separate appendages that increase the overall footprint, are vulnerable to wind damage during transport and installation, and do not address solar heat gain on the enclosure walls. An integrated approach that incorporates solar heat dissipation into both the wall assembly and the roof structure as part of a unitary enclosure architecture has not been previously realized in the battery energy storage context.

The building construction industry has developed and validated highly effective wall assembly systems for managing thermal loads, fire resistance, and moisture in exterior envelopes. High-performance building envelopes employ continuous mineral wool insulation that is inherently non-combustible and maintains structural integrity at temperatures exceeding 2,000 degrees Fahrenheit, fire-resistant cementitious sheathing, vapor management membranes, and drained-and-ventilated rainscreen cladding systems in which fiber cement siding is mounted over furring strips to create a ventilated drainage gap. These multi-layer assemblies have demonstrated exceptional thermal stability, fire containment, and moisture management in building applications across extreme climates. However, these building science principles have not been integrated into a standalone, transportable battery energy storage cabinet. The battery enclosure industry continues to derive its design paradigms from industrial electrical cabinet construction rather than from high-performance building envelope engineering, leaving a significant gap between what is achievable in enclosure thermal performance and fire resistance and what is currently available in the market.

The market for residential battery energy storage includes both indoor-rated and outdoor-rated battery units. Indoor-rated batteries, designed for installation within conditioned spaces, typically offer cost advantages and a greater variety of available models compared to outdoor-rated alternatives that incorporate their own environmental protection features. However, existing outdoor enclosure systems fail to provide the environmental conditions necessary for safely housing indoor-rated components in an outdoor setting. An enclosure that could reliably maintain the temperature, humidity, and fire-protection conditions expected by indoor-rated batteries would significantly expand equipment selection options for system integrators while reducing overall system cost. Standard 19-inch server rack form factor batteries, widely available and competitively priced for indoor deployment, represent a particularly attractive target for outdoor enclosure integration, yet no existing enclosure has been specifically engineered to create an indoor-equivalent environment within an outdoor cabinet using passive building-science principles.

Space utilization and aesthetic considerations further limit the adoption of current battery storage solutions. Indoor installations consume valuable floor area in garages, basements, or utility rooms. Outdoor installations, when poorly designed, present an industrial appearance with exposed conduit, junction boxes, and cooling equipment that conflicts with residential architectural aesthetics. Exposed wiring and conduit are also vulnerable to physical damage from accidental impact, wildlife interference, ultraviolet degradation, and unauthorized tampering. Homeowners and property managers increasingly demand battery storage solutions that integrate seamlessly into the residential landscape without compromising the visual character of the property.

Installation complexity represents a significant barrier to broader adoption of residential battery storage. Many current systems require extensive on-site assembly, custom conduit routing visible on exterior walls, and coordination among multiple trades including electrical, concrete, and HVAC contractors. The lack of pre-integrated, transportable enclosure solutions forces system integrators to design and construct enclosures in the field, increasing labor costs, extending project timelines, and introducing variability in construction quality. Furthermore, large enclosures must be transported to the installation site and positioned using heavy equipment, requiring structural provisions for lifting and placement that many current designs omit.

These various challenges highlight a significant unmet need for an outdoor battery storage enclosure that treats the enclosure itself as a high-performance building envelope, applying proven building science principles to achieve thermal stability, fire resistance, and moisture management without heavy reliance on active environmental control systems. No existing solution integrates a multi-layer, non-combustible wall assembly with a rainscreen drainage gap, a vented roof air gap for solar heat dissipation, a non-communicating insulated partition between battery and inverter compartments, and a passive ventilation path hermetically isolated from the wall cavities into a single, transportable cabinet suitable for residential deployment. Such an enclosure would reduce parasitic energy consumption, improve safety during thermal events, enable the use of more economical indoor-rated battery equipment, and present an aesthetically acceptable installation suitable for zero-clearance residential environments.

### SUMMARY OF THE INVENTION

In accordance with an embodiment of the present invention, an outdoor energy storage enclosure system is provided that addresses the foregoing challenges through a high-performance enclosure architecture in which the enclosure wall system itself serves as the primary mechanism for thermal regulation, fire resistance, and moisture management. The enclosure system comprises a structural housing having a multi-layer wall assembly, a roof assembly incorporating a vented air gap, physically separated battery and inverter compartments, and a base structure with integrated conduit routing and structural provisions for transport. The multi-layer wall assembly employs mineral wool insulation, fire-resistant sheathing, a fire-retardant vapor barrier, rainscreen furring strips defining a drainage and ventilation gap, and exterior fiber cement siding to create a continuous, high-performance building envelope adapted specifically for energy storage applications. The invention represents a cross-domain integration of building science principles into the battery energy storage enclosure context, creating a synergistic thermal and fire containment system that fundamentally differs from existing industrial cabinet, single-wall appliance, and shipping container approaches.

The enclosure architecture physically separates the battery compartment from the inverter compartment using an insulated partition, ensuring that no airflow is shared between the two compartments. This non-communicating isolation prevents thermal cross-contamination in which inverter waste heat would otherwise migrate into the temperature-sensitive battery compartment, a deficiency present in centralized-cooling designs that manage both compartments with a single HVAC system. The inverter utilizes its own internal active cooling system and dissipates heat through the metal frame of the inverter compartment, while the battery compartment benefits primarily from the passive thermal buffering provided by the multi-layer wall assembly and the vented roof air gap. Supplemental active thermal management is provided by a heater for cold-weather operation and thermostat-controlled fans for elevated temperature conditions. These active systems operate on an as-needed basis and are supplemental to the substantial passive thermal performance of the enclosure, establishing a passive-first thermal management hierarchy in which the enclosure architecture performs the majority of the thermal regulation work.

The roof assembly incorporates a vented air gap between the outer roof surface and the internal roof structure, reducing solar heat gain by allowing heated air to convect and dissipate before thermal energy reaches the insulated interior. The rainscreen drainage and ventilation gap within the multi-layer wall assembly similarly dissipates solar heat absorbed by the exterior cladding before that heat can conduct through the sheathing and insulation layers. Together, the vented roof air gap and the rainscreen ventilation gap form a dual-convective thermal dissipation system that creates a continuous blanket of moving ambient air around the insulated core of the enclosure, substantially attenuating solar heat gain on all major exterior surfaces. This dual-convective architecture provides a level of passive solar load mitigation that neither bolt-on solar shields nor simple double-wall enclosures can achieve. Passive ventilation within the battery compartment is achieved through intake openings positioned at a lower portion of the enclosure and exhaust openings at an upper portion, providing direct-to-atmosphere gas venting. This ventilation path is hermetically isolated from the wall cavities of the multi-layer wall assembly, ensuring that any gases produced during a battery thermal event are expelled to the exterior atmosphere without contacting or degrading the insulation, sheathing, or vapor barrier materials within the wall assembly.

The base structure of the enclosure integrates a conduit routing area that allows all electrical connections, including power conductors and control wiring, to be run beneath the enclosure in concealed pathways. This hidden conduit routing eliminates exposed exterior wiring, improving both safety and aesthetic appearance. The base structure further incorporates forklift pockets to facilitate transport and placement of the pre-assembled enclosure at the installation site, enabling efficient deployment without the need for crane equipment.

The multi-layer wall assembly contributes simultaneously to thermal performance, fire resistance, moisture management, and reduced reliance on active environmental control. The mineral wool insulation provides continuous thermal buffering and is inherently non-combustible, maintaining structural integrity at temperatures exceeding those encountered during battery thermal runaway events, in contrast to foam-based insulations employed in conventional double-wall enclosures that are themselves combustible and can contribute to fuel load during a fire. The fire-resistant fiber cement sheathing and fire-retardant vapor barrier provide additional layers of fire containment. The rainscreen drainage gap manages bulk water and allows drying of any moisture that penetrates the outer cladding, preventing long-term moisture accumulation within the wall assembly. Together, these layers create an enclosure that stabilizes internal temperature across extreme outdoor conditions, reduces the energy required for active heating and cooling, and provides passive fire containment and thermal buffering during battery fault conditions for a rated period without reliance on active chemical suppression systems.

In further embodiments, the enclosure system accommodates standard server rack mounted battery units within the battery compartment, maintains an overall height of less than 96 inches to facilitate transportation on standard semi-trailer trucks, and enables integration with various external power sources including solar photovoltaic arrays and building electrical systems. By creating an interior environment that replicates the temperature, humidity, and fire-protection conditions of a conditioned indoor space, the enclosure enables the safe outdoor deployment of indoor-rated, standard 19-inch rack-mount battery units that are typically less expensive and more widely available than outdoor-rated alternatives. The enclosure is designed to enable outdoor energy storage that does not require a separately conditioned space, uses minimal energy to maintain operating temperature, and improves safety during thermal events in compliance with UL 9540 and UL 9540A requirements.

### BRIEF DESCRIPTION OF THE DRAWINGS

FIG. 1 is a front perspective view of the enclosure system 100 illustrating the roof assembly 101, exhaust ventilation openings 102, base structure 110, exterior siding 145, and battery compartment access doors 150 in accordance with an embodiment of the invention.

FIG. 2 is a side elevation view of the enclosure system 100 showing the roof assembly 101, battery rack system 120, and exterior siding 145 in accordance with an embodiment of the invention.

FIG. 3 is a rear perspective view of the enclosure illustrating the roof assembly 101, thermostat-controlled fans 103, battery rack system 120, and base structure 110 in accordance with an embodiment of the invention.

FIG. 4 is an alternative elevation view of the enclosure showing the roof assembly 101, inverter compartment 130, multi-layer wall assembly 140, insulation 141, and exterior siding 145 with access doors in accordance with an embodiment of the invention.

FIG. 5 is a schematic site plan view depicting the enclosure system 100 and inverter compartment 130 in relation to a building 300 and solar panel array 301, including buried wiring connections between components in accordance with an embodiment of the invention.

FIG. 6 is an exploded view of the multi-layer wall assembly showing, from interior to exterior, structural frame members 140, mineral wool insulation 141, fire-resistant sheathing 142, fire-retardant vapor barrier 143, rainscreen furring strips 144, and exterior fiber cement siding 145 in accordance with an embodiment of the invention.

FIG. 7 is a cross-sectional view illustrating airflow paths through the vented roof air gap of the roof assembly 101, the multi-layer wall assembly 140, the insulated partition 104, and the inverter compartment 130 in accordance with an embodiment of the invention.

FIG. 8 is an exploded perspective view of the enclosure showing the multi-layer wall assembly 140, insulated partition 104, heater 105, base structure 110, forklift pockets 111, and inverter compartment 130 in accordance with an embodiment of the invention.

FIG. 9 is a front cross-sectional view of the enclosure illustrating the roof assembly 101, exhaust ventilation openings 102, heater 105, base structure 110, battery rack system 120, passive ventilation intake 121, inverter compartment 130, multi-layer wall assembly 140, insulation 141, and exterior siding 145 in accordance with an embodiment of the invention.

FIG. 10 is a functional block diagram of the thermal management system 200 depicting the inverter section 210 with self-contained inverter 211, active thermal systems 220 including thermostat-controlled cooling fans 221 and active heating system 222, passive thermal systems 230 including passive ventilation path 231, multi-layer wall assembly 232, and vented roof air gap 233, and their interaction with the external environment 240 in accordance with an embodiment of the invention.

### DETAILED DESCRIPTION OF THE INVENTION

Reference will now be made in detail to embodiments of the present invention, examples of which are illustrated in the accompanying drawings. Wherever possible, the same reference numerals are used throughout the drawings to refer to the same or like parts. The following detailed description is provided to enable any person skilled in the art to make and use the invention and sets forth the best modes contemplated by the inventor for carrying out the invention.

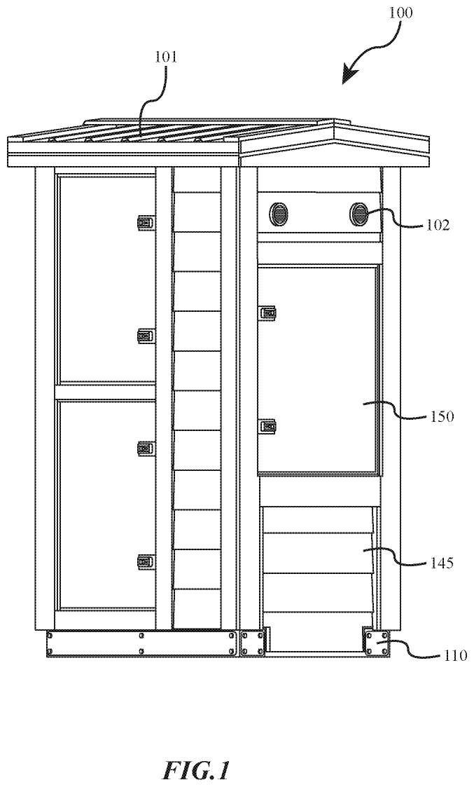

Referring now to FIGS. 1 through 9, an outdoor energy storage enclosure system 100 is shown in various views and cross-sections. The enclosure system 100 is a standalone, pre-assembled unit configured to house both battery energy storage equipment and power conversion equipment in a thermally managed, fire-resistant, and moisture-controlled environment suitable for outdoor installation. In an exemplary embodiment, the enclosure system 100 provides approximately 46 kilowatt-hours of energy storage capacity, although the enclosure architecture is scalable to accommodate varying storage capacities. The primary area of novelty resides in the enclosure itself as a high-performance wall system, rather than in the specific battery chemistry or ventilation mechanisms housed within.

The enclosure system 100 represents a cross-domain integration of high-performance building envelope engineering into the battery energy storage enclosure context. Unlike conventional battery enclosures derived from industrial electrical cabinet or shipping container paradigms, the enclosure system 100 applies building science principles, including continuous non-combustible insulation, vapor management, drained-and-ventilated rainscreen cladding, and vented roof assemblies, that have been extensively validated in the building construction industry for managing thermal loads, fire resistance, and moisture in exterior wall assemblies. This cross-domain application creates a synergistic thermal and fire management system in which the multi-layer wall assembly 140, the vented roof air gap of the roof assembly 101, the insulated partition 104, and the passive ventilation system cooperate to produce a controlled interior environment that cannot be replicated by any single prior art approach. The result is an enclosure that functions not merely as a protective box for batteries, but as a multi-modal thermal infrastructure in which the enclosure architecture itself performs the majority of thermal management, fire containment, and moisture control.

The enclosure system 100 comprises a structural housing that defines an interior volume within which the battery compartment and inverter compartment are disposed. The structural housing is constructed from a welded steel frame comprising vertical support posts at each corner interconnected by horizontal cross members, with additional intermediate vertical and horizontal members providing mounting points for internal components and enhancing structural rigidity. The overall height of the enclosure system 100 is maintained below 96 inches to facilitate loading and transportation on standard semi-trailer trucks while providing sufficient internal volume for all system components. The width and depth of the housing are proportioned to accommodate the internal compartments, the multi-layer wall assembly, and the roof assembly while maintaining stability when mounted on a foundation. The welded steel frame is engineered with full penetration welds at critical structural joints and reinforced gussets at load-bearing points, providing sufficient structural integrity to support the weight of nine fully loaded battery units, the inverter equipment, and the complete multi-layer wall assembly during transport and seismic events.

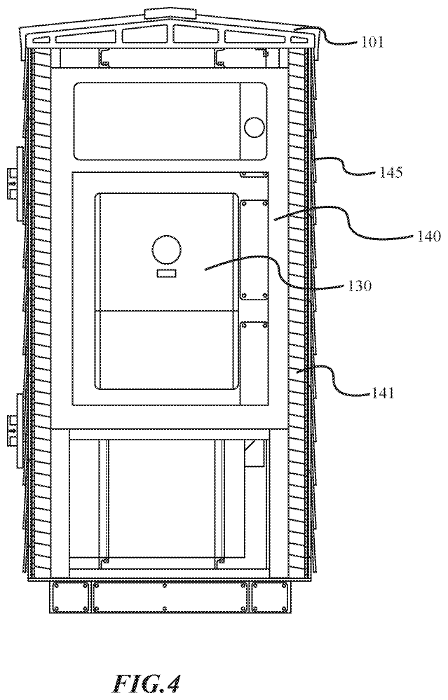

Referring particularly to FIGS. 4, 6, 7, and 9, the enclosure system 100 features a multi-layer wall assembly 140 forming at least a substantial portion of the exterior walls of the structural housing. The multi-layer wall assembly 140 is designed as a high-performance building envelope adapted specifically for energy storage applications, applying principles of building science including continuous insulation, vapor management, and drained-and-ventilated rainscreen cladding to the enclosure context. The wall assembly 140 contributes simultaneously to thermal performance, fire resistance, moisture management, and reduced reliance on active environmental control. In the exemplary embodiment, the multi-layer wall assembly 140 comprises, in order from the interior side to the exterior side, the following layers: mineral wool insulation 141 disposed between structural frame members; a fire-resistant sheathing layer 142; a fire-retardant vapor barrier 143 applied to the sheathing; rainscreen furring strips 144 defining a drainage and ventilation gap; and exterior fiber cement siding 145.

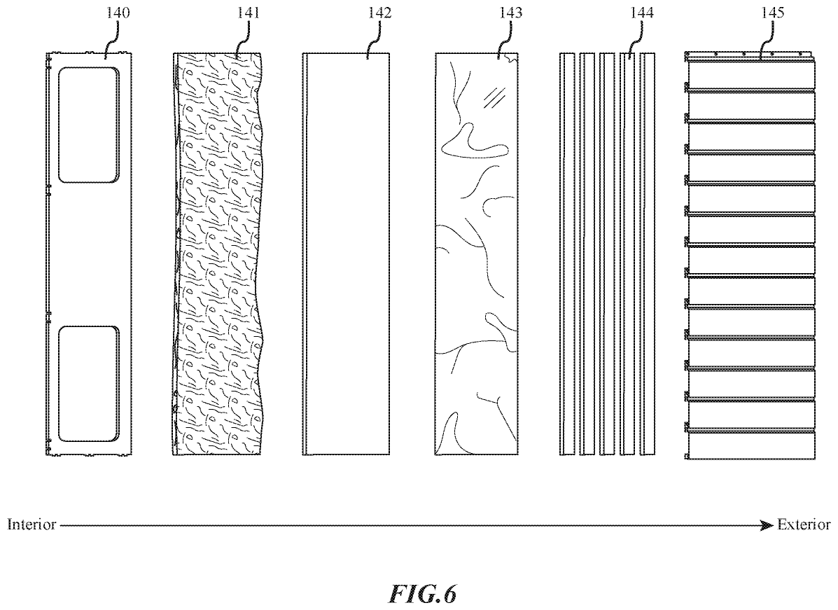

Referring to FIG. 6, the structural frame members of the wall assembly 140 comprise steel studs or channels arranged to define cavities within the wall depth. Mineral wool insulation 141 is disposed within these cavities, filling the spaces between structural frame members to provide continuous thermal and acoustic insulation. Mineral wool insulation 141 is selected for its combination of thermal resistance, fire resistance, and moisture tolerance. Unlike foam-based insulations such as expanded polystyrene or polyurethane commonly employed in double-walled industrial enclosures, mineral wool is inherently non-combustible, with a melting point exceeding 2,000 degrees Fahrenheit, and it maintains its structural integrity and insulating value when exposed to the extreme temperatures that may occur during a battery thermal runaway event. This non-combustible characteristic ensures that the insulation material does not contribute to fuel load during a fire, a critical distinction from foam-insulated sandwich panel enclosures in which the insulation itself can accelerate thermal propagation. The mineral wool insulation 141 is carefully fitted between structural members to minimize thermal bridges and maintain continuous insulation coverage around the battery compartment.

Outboard of the mineral wool insulation 141, a fire-resistant sheathing layer 142 is attached to the exterior faces of the structural frame members. In the exemplary embodiment, the fire-resistant sheathing 142 comprises fiber cement board, which provides a non-combustible, dimensionally stable substrate for the subsequent vapor barrier and cladding layers. The fiber cement sheathing 142 serves as a structural backer, a fire barrier, and a secondary weather-resistive surface. The sheathing 142 is fastened to the structural frame members using corrosion-resistant mechanical fasteners at spacing intervals sufficient to resist wind loads and maintain panel flatness.

A fire-retardant vapor barrier 143 is applied to the outward-facing surface of the fire-resistant sheathing 142. In the exemplary embodiment, the vapor barrier 143 is a roll-on or paint-on membrane that incorporates fire-retardant chemical compounds integrated into the barrier material. The vapor barrier 143 performs a dual function: it controls vapor diffusion to prevent moisture migration into the mineral wool insulation 141, and it provides an additional layer of fire protection through chemical compounds that activate when exposed to elevated temperatures. The vapor barrier 143 is applied as a continuous membrane with sealed penetrations at all conduit passages and careful detailing at joints to maintain barrier continuity. Together with the fiber cement sheathing 142, the vapor barrier 143 forms a fire-resistant and moisture-controlling intermediate layer within the wall assembly 140.

Outboard of the vapor barrier 143, a plurality of rainscreen furring strips 144 are attached to the sheathing 142 to define a drainage and ventilation gap between the sheathing and the outermost cladding layer. The furring strips 144 in the exemplary embodiment comprise fiber cement strips oriented to create vertical drainage channels. In a preferred embodiment, the rainscreen drainage and ventilation gap has a depth of approximately 0.75 inches. The rainscreen gap serves multiple functions: it provides a capillary break preventing bulk water that penetrates the siding from reaching the sheathing; it creates a ventilated cavity that promotes drying of any moisture within the wall assembly; and it equalizes air pressure across the siding layer, reducing the pressure differential that drives wind-driven rain through cladding joints. This rainscreen approach represents a significant advancement over single-barrier waterproofing methods typically employed in battery enclosure design.

The outermost layer of the multi-layer wall assembly 140 is exterior siding 145, which in the exemplary embodiment comprises fiber cement siding panels. The exterior siding 145 is a non-combustible, weather-resistant cladding material that provides the primary defense against precipitation, ultraviolet radiation, and physical impact. The fiber cement siding 145 is classified as noncombustible per ASTM E136 and achieves a Class A fire rating per ASTM E84, providing an exterior fire barrier that does not ignite, contribute flame spread, or generate significant smoke. The fiber cement siding 145 is installed over the rainscreen furring strips 144 using corrosion-resistant fasteners, and is finished in a manner compatible with residential architectural aesthetics. The selection of fiber cement for both the sheathing 142 and the siding 145 ensures that the entire wall assembly, from interior insulation to exterior cladding, is constructed of non-combustible materials, providing continuous fire resistance through the full depth of the wall.

In addition to its moisture management function, the rainscreen drainage and ventilation gap defined by the furring strips 144 provides a critical thermal dissipation function that distinguishes the multi-layer wall assembly 140 from conventional double-wall enclosures. When the exterior siding 145 absorbs solar radiation, the heated siding transfers thermal energy to the air within the rainscreen gap by convection. The ventilated gap allows this heated air to rise and exit at the top of the wall, carrying absorbed solar energy away from the enclosure before it can conduct through the sheathing 142, vapor barrier 143, and insulation 141 to the interior. This convective heat dissipation mechanism operates passively and continuously during daylight hours, creating a dynamic thermal buffer between the solar-heated exterior cladding and the insulated interior. In contrast, conventional double-wall enclosures that employ a static, sealed air gap between inner and outer skins lack this convective flushing capability, and the trapped air within the gap can itself become a thermal bridge as it heats from solar absorption. The ventilated rainscreen gap thus performs a fundamentally different thermal function than a simple double-wall air space, actively reducing the thermal load on the insulation layer before conduction can occur.

The collective thermal performance of the multi-layer wall assembly 140 stabilizes the internal temperature of the enclosure system 100 across extreme outdoor conditions. The mineral wool insulation 141 provides a high thermal resistance value that retards heat transfer between the interior compartments and the exterior environment. The rainscreen ventilation gap behind the siding 145 dissipates solar heat absorbed by the cladding before it can conduct through the sheathing and insulation layers. The result is a passively managed thermal envelope that significantly reduces the duty cycle and energy consumption of any supplemental active heating or cooling systems, enabling the enclosure to maintain battery-safe temperatures with minimal parasitic energy draw.

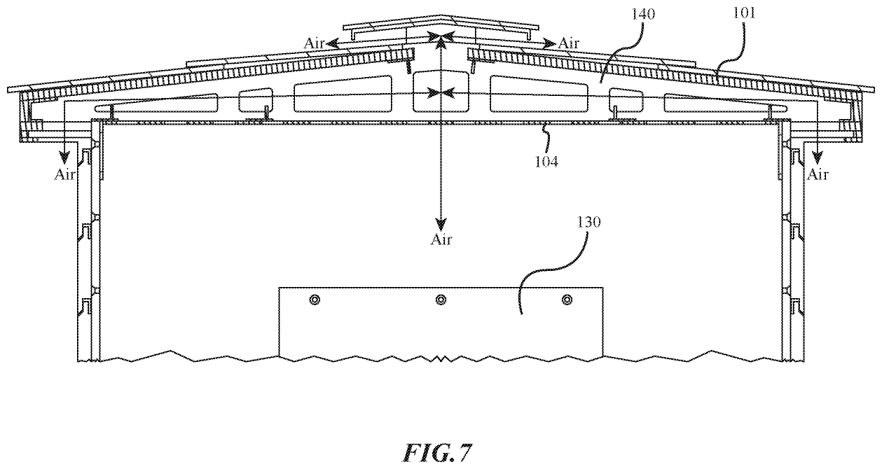

Referring to FIGS. 1 through 4, 7, and 9, the roof assembly 101 is disposed atop the structural housing of the enclosure system 100. The roof assembly 101 comprises an outer roof surface spaced apart from an underlying inner roof structure to define a vented air gap therebetween. As best seen in the cross-sectional view of FIG. 7, the vented air gap allows ambient air to enter at one edge of the roof, flow across the underside of the outer roof surface, and exit at an opposing edge. Solar radiation impinging on the outer roof surface heats that surface, and the heated air within the vented gap rises and convects outward, carrying thermal energy away from the enclosure before it can conduct through the inner roof structure to the insulated compartments below. This vented roof air gap is structurally integrated into the unitary roof assembly 101 as a permanent component of the cabinet architecture, rather than being a separate bolt-on shield or external appendage. This integrated construction provides a robust, transport-ready solar heat mitigation system that does not increase the overall footprint of the enclosure and is not vulnerable to displacement during transport or high-wind conditions.

The inner roof structure beneath the vented air gap is insulated to further retard heat transfer into the enclosure interior. In the exemplary embodiment, mineral wool insulation is disposed within or beneath the inner roof structure, providing thermal resistance consistent with the wall insulation system. The combination of the vented air gap and the insulated inner roof structure provides a two-stage thermal barrier at the roof plane, which is typically the surface receiving the greatest solar heat load on an outdoor enclosure.

Referring to FIGS. 6, 7, and 9, the vented roof air gap of the roof assembly 101 and the rainscreen drainage and ventilation gap defined by the furring strips 144 of the multi-layer wall assembly 140 cooperatively form a dual-convective thermal dissipation system. Along the vertical wall surfaces, solar heat absorbed by the exterior siding 145 is conveyed upward through the rainscreen gap by natural convection, creating a continuous upward flow of air that carries absorbed solar energy away from the insulated wall core. At the roof plane, solar heat absorbed by the outer roof surface is similarly conveyed across the vented air gap by natural convection and expelled at the roof edges. Together, these two convective pathways create a continuous envelope of moving ambient air around the major heat-receiving surfaces of the enclosure, forming what may be characterized as a passive thermal jacket that intercepts and dissipates solar energy before it can penetrate to the insulation layers. This dual-convective architecture provides a level of passive solar load reduction that cannot be replicated by bolt-on solar shields, which address only the roof surface, or by sealed double-wall enclosures, which lack convective flushing capability. The practical result is that the internal temperature of the battery compartment is substantially decoupled from the solar radiation intensity on the exterior surfaces, enabling the enclosure to maintain target operating temperatures in high-insolation desert environments with minimal active cooling input.

Referring to FIGS. 1, 2, 3, and 9, the enclosure system 100 includes a battery compartment disposed within the interior volume and configured to receive one or more energy storage units. In the exemplary embodiment, the battery compartment is divided into upper and lower sub-compartments by a horizontal structural member. Each sub-compartment is configured to house multiple battery units; in a preferred configuration, the lower sub-compartment accommodates five battery units and the upper sub-compartment accommodates four battery units, for a total capacity of nine battery units, although the sub-compartment dimensions may be varied to accommodate different battery counts and form factors.

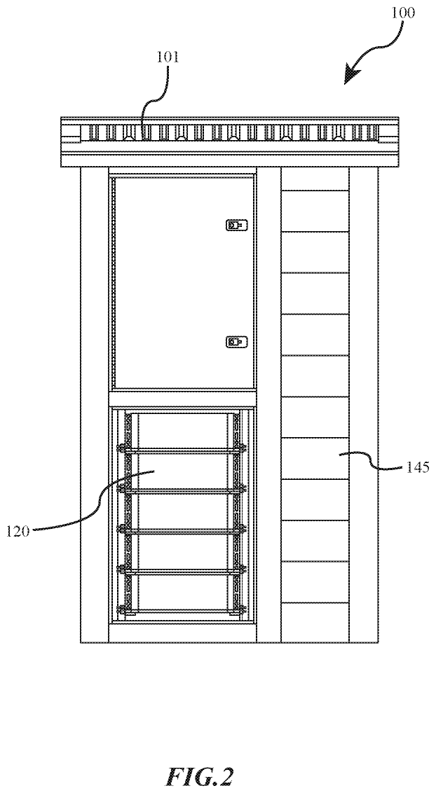

A battery rack system 120, best shown in FIGS. 2, 3, and 9, is installed within each sub-compartment. The battery rack system 120 comprises standard server rack rails mounted to vertical support members within the enclosure frame. The server rack rails are configured to accept standard 19-inch rack-mount battery units and include adjustable mounting points and load ratings appropriate for the weight of the installed batteries. The rack system 120 enables individual batteries to be slid into and out of position on the rails for installation, replacement, and maintenance. Anti-vibration features are incorporated into the rail mounting system to minimize movement during seismic events or transport. Appropriate spacing between battery units on the rack system 120 allows for air circulation and cooling around each battery.

The battery compartment, enclosed by the multi-layer wall assembly 140, the insulated partition 104, and the insulated access doors 150, creates an interior environment that replicates the temperature, humidity, and fire-protection conditions of a conditioned indoor space. This indoor-equivalent environment enables the enclosure system 100 to safely house indoor-rated, standard 19-inch server rack battery units in an outdoor setting. Indoor-rated batteries are typically designed for installation within air-conditioned server rooms or utility closets and are not inherently protected against the temperature extremes, moisture, and direct solar exposure encountered in outdoor installations. By providing the environmental conditions that indoor-rated batteries expect, the enclosure system 100 bridges the gap between the large and cost-effective market of indoor-rated battery equipment and the growing need for outdoor energy storage deployment. This capability represents a significant economic advantage over systems that require specialized outdoor-rated batteries, which incorporate redundant environmental protection features and command a price premium.

Referring to FIGS. 1 and 4, the battery compartment is accessed through battery compartment access doors 150. In the exemplary embodiment, each sub-compartment is provided with a separate insulated access door. The access doors 150 incorporate multiple layers of insulating material, including mineral wool insulation, sandwiched between metal panels to provide both thermal insulation and fire protection consistent with the performance of the multi-layer wall assembly 140. Weather-resistant gasket seals are installed around the entire perimeter of each door opening, and intumescent seals that expand when exposed to heat create an effective barrier against fire spread. Robust hinges welded to the frame structure and multi-point latching mechanisms maintain a secure seal when the doors are closed.

Referring to FIGS. 4, 5, 7, 8, and 9, the inverter compartment 130 is disposed within the interior volume of the enclosure system 100 and is physically separated from the battery compartment. The inverter compartment 130 is configured to house power conversion equipment, including a self-contained inverter having its own internal active cooling system. The inverter compartment 130 is sized to accommodate standard power conversion equipment with adequate clearance for ventilation, heat dissipation, and maintenance access. In the exemplary embodiment, the inverter compartment 130 is accessed through a separate door, which may be non-insulated or lightly insulated, reflecting the distinct thermal management requirements of the inverter equipment relative to the battery compartment. The metal exterior frame construction of the inverter compartment 130 facilitates thermal conductivity, allowing inverter waste heat to transfer efficiently from the interior to the exterior of the cabinet through the frame members, which function as a passive heat sink.

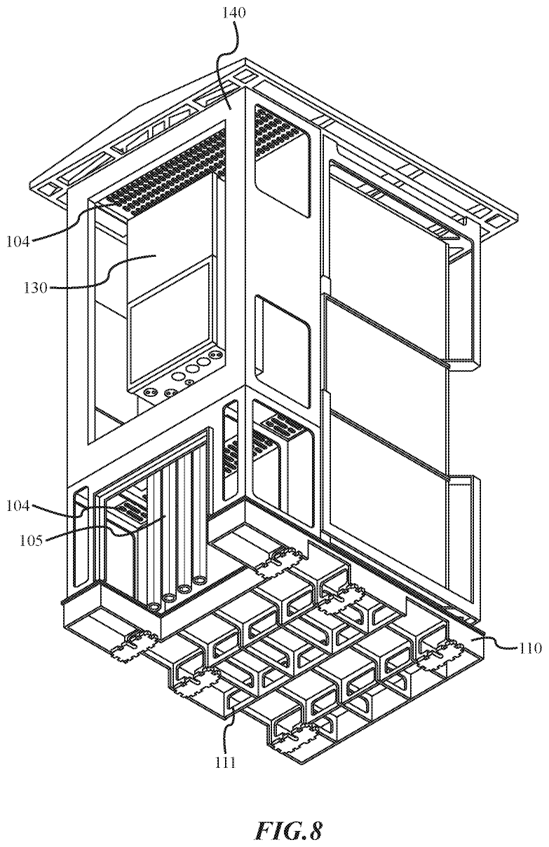

As best shown in FIGS. 7 and 8, an insulated partition 104 is disposed between the battery compartment and the inverter compartment 130 within the enclosure system 100. The insulated partition 104 physically separates the two compartments and prevents any shared airflow between them. This separation is significant because the inverter generates substantial waste heat during power conversion operations, and allowing that heat to transfer into the temperature-sensitive battery compartment would increase the cooling load and potentially compromise battery life. By isolating the inverter compartment 130 with the insulated partition 104, each compartment can be thermally managed independently: the inverter relies on its own internal cooling and dissipates heat through the metal frame, while the battery compartment benefits from the passive thermal envelope of the multi-layer wall assembly 140. The insulated partition 104 also provides an additional fire barrier between the compartments, limiting the propagation of any thermal event from one compartment to the other.

The non-communicating thermal isolation provided by the insulated partition 104 represents a departure from the prevailing industry approach of centralized cooling, in which a single HVAC system manages the thermal environment of both battery and inverter equipment within a shared air volume. In centralized-cooling designs, inverter waste heat enters the battery compartment through shared air pathways, forcing the cooling system to simultaneously remove inverter heat and maintain battery temperature, increasing both the cooling capacity required and the energy consumed. The insulated partition 104 of the enclosure system 100 eliminates this thermal cross-contamination by creating a zero-airflow boundary between the two compartments. The inverter compartment 130, with its non-insulated or lightly-insulated construction and metal frame, is optimized for heat dissipation, allowing inverter waste heat to transfer outward through the frame rather than inward toward the batteries. Simultaneously, the battery compartment, surrounded by the multi-layer wall assembly 140 and sealed by the insulated partition 104, is optimized for thermal retention and stability, maintaining a controlled temperature range independent of inverter operating cycles. This synchronized divergence of thermal management strategies within a single enclosure, one compartment designed for heat rejection and the other for thermal retention, creates a thermodynamic optimization that reduces the overall energy consumption of the active thermal management systems and extends battery service life.

Referring to FIGS. 1, 7, and 9, the enclosure system 100 includes a passive ventilation system for the battery compartment. The passive ventilation system comprises one or more passive ventilation intake openings 121 positioned at a lower portion of the battery compartment and one or more exhaust ventilation openings 102 positioned at an upper portion of the battery compartment. This bottom-intake, top-exhaust configuration leverages natural convective airflow: warmer air rises within the compartment and exits through the upper exhaust openings 102, drawing cooler ambient air in through the lower intake openings 121. The passive ventilation provides direct-to-atmosphere gas venting, meaning that any gases produced during a battery thermal event are exhausted directly to the exterior atmosphere without being routed through wall cavities or other enclosed spaces within the enclosure structure. This direct venting path preserves the integrity of the multi-layer wall assembly 140 by preventing potentially corrosive or flammable gases from contacting insulation, sheathing, or vapor barrier materials within the wall cavities.

The passive ventilation path through the intake openings 121 and exhaust openings 102 is hermetically isolated from the wall cavities of the multi-layer wall assembly 140. This isolation ensures that gases vented from the battery compartment during a thermal event, which may include flammable hydrogen, carbon monoxide, and corrosive electrolyte vapors, travel directly from the battery compartment to the exterior atmosphere without entering the spaces between the insulation 141, sheathing 142, vapor barrier 143, or siding 145. In contrast, existing battery enclosure designs that route ventilation air along or through wall surfaces expose the wall materials to potentially degrading gases, which can compromise the insulating value and fire resistance of the wall assembly over time and during fault conditions. By maintaining a strict separation between the gas venting pathway and the wall assembly cavities, the enclosure system 100 preserves the long-term integrity and fire-containment capability of the multi-layer wall assembly 140 even after a thermal runaway event, enabling the enclosure to provide continued protection for remaining battery units and adjacent structures.

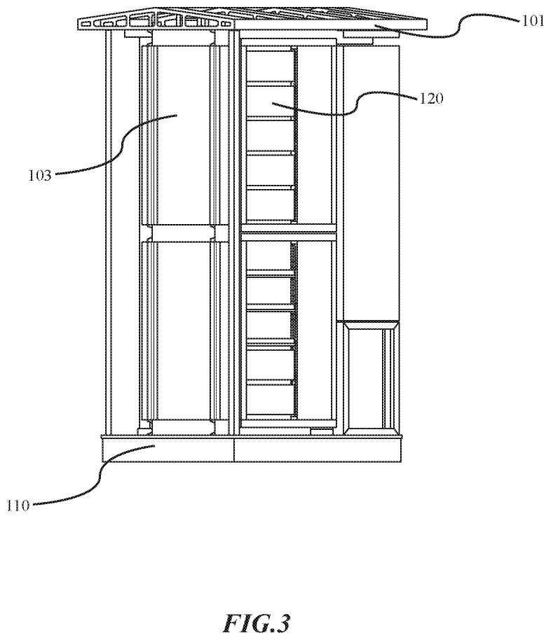

Referring to FIG. 3, the enclosure system 100 includes one or more thermostat-controlled fans 103 associated with the battery compartment. The thermostat-controlled fans 103 are activated when the internal temperature of the battery compartment exceeds a predetermined upper threshold, providing supplemental forced-air ventilation to assist with heat removal during periods of elevated ambient temperature or high charge/discharge rates. The thermostat-controlled fans 103 operate as a secondary thermal management mechanism that supplements the passive thermal performance provided by the multi-layer wall assembly 140 and the vented roof air gap, rather than serving as the primary means of temperature regulation.

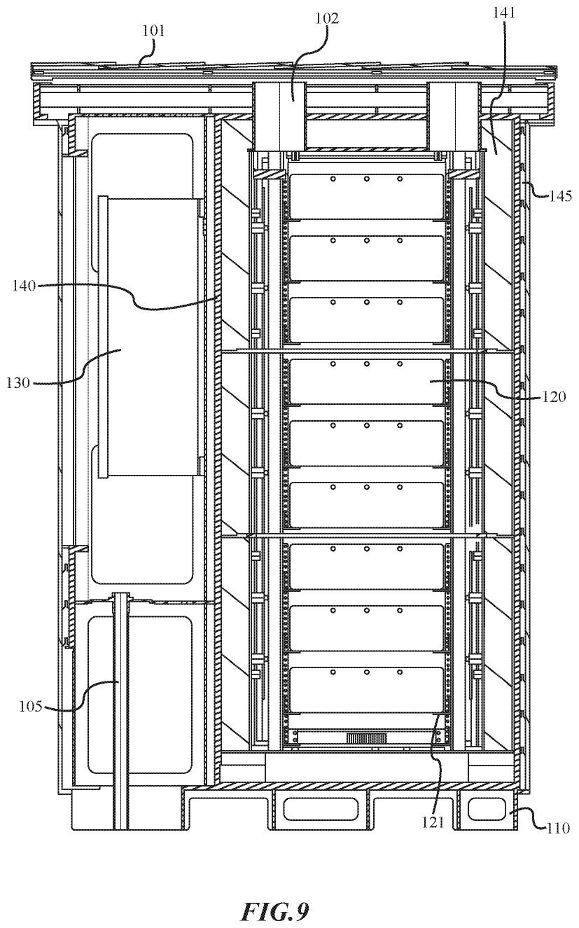

Referring to FIGS. 8 and 9, a heater 105 is disposed within the battery compartment of the enclosure system 100. The heater 105 is configured to maintain the internal temperature of the battery compartment above a predetermined lower threshold during cold-weather operation, protecting the battery units from low-temperature conditions that can degrade performance and reduce cycle life. In the exemplary embodiment, the heater 105 comprises an electric heating element positioned within the battery compartment and controlled by the same digital thermostat system that governs the thermostat-controlled fans 103. The heater 105 includes safety cutoffs and thermal protection circuits to prevent overheating. As with the fans 103, the heater 105 operates as a supplemental system, with the thermal mass and insulation of the multi-layer wall assembly 140 providing substantial temperature buffering that reduces the frequency and duration of heater operation.

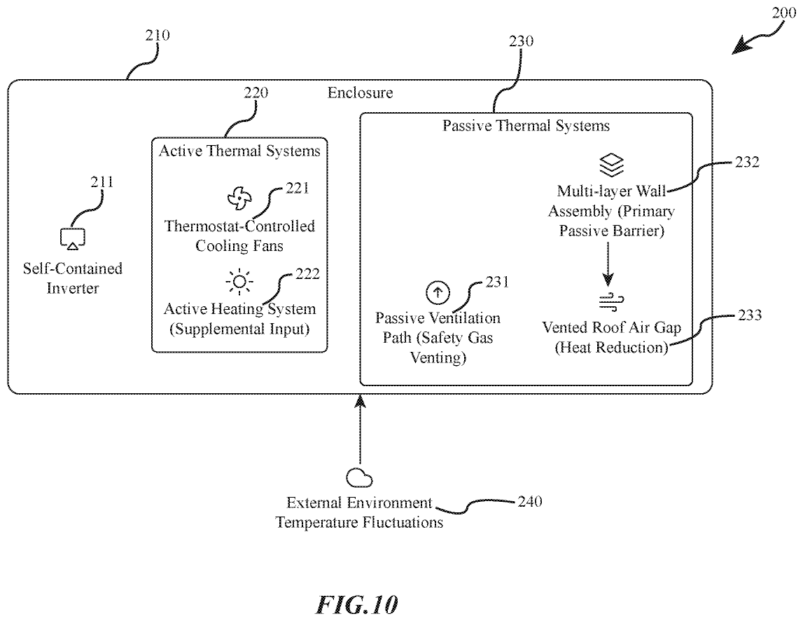

Referring to FIG. 10, the overall thermal management approach of the enclosure system 100 is illustrated in a functional block diagram designated generally as system 200. The system 200 comprises an inverter section 210 housing a self-contained inverter 211 having its own internal cooling mechanism, and a battery section having passive thermal systems 230 as the primary thermal regulation mechanism including the multi-layer wall assembly 140 and the vented roof air gap, supplemented by active thermal systems 220 comprising thermostat-controlled cooling fans 221 and active heating system 222 that operate only when passive performance is insufficient to maintain the target operating temperature range.

The passive-first thermal management hierarchy of the enclosure system 100 produces a measurable reduction in parasitic energy consumption compared to conventional enclosure designs that rely primarily on active cooling. In conventional single-wall or double-wall metallic enclosures, the HVAC or liquid cooling system must continuously compensate for solar heat gain conducted through the enclosure walls and roof, as well as for inverter waste heat entering a shared battery compartment. In the enclosure system 100, the multi-layer wall assembly 140 and the vented roof air gap of the roof assembly 101 intercept and dissipate the solar heat load passively, while the insulated partition 104 prevents inverter waste heat from reaching the battery compartment. The net result is that the active thermal systems 220, including the thermostat-controlled fans 103 and the heater 105, operate for shorter durations and at lower duty cycles, reducing the parasitic energy draw of the enclosure and increasing the net energy available from the stored battery capacity. In the exemplary embodiment, the enclosure system 100 is capable of maintaining a target battery operating temperature of approximately 77 degrees Fahrenheit across a wide range of ambient conditions with significantly less active energy input than would be required by a conventional enclosure of comparable storage capacity.

In operation, the thermostat control system monitors battery compartment temperature through one or more sensors and implements differential temperature control with programmable setpoints for both heating and cooling operations. In the exemplary embodiment, the heater 105 is activated when the battery compartment temperature falls below a lower threshold and is deactivated when the temperature returns to the target range, and the thermostat-controlled fans 103 are activated when the temperature exceeds an upper threshold. Both the heater 105 and the thermostat-controlled fans 103 are sized and configured to operate as supplemental systems, with the expectation that the passive thermal envelope provided by the multi-layer wall assembly 140 will maintain the battery compartment temperature within or near the target operating range without active intervention under typical ambient conditions.

Referring to FIGS. 1, 3, 8, and 9, the enclosure system 100 includes a base structure 110 that supports the structural housing and provides additional functional features. The base structure 110 comprises a steel frame assembly configured for mounting on a concrete pad foundation or other suitable support surface. Mounting brackets welded to the base frame align with threaded anchors embedded in the foundation, enabling secure attachment with appropriate leveling capability. The base structure 110 integrates a conduit routing area beneath the battery and inverter compartments, providing concealed pathways for all electrical connections including power conductors, control wiring, and communication cables. This base-integrated conduit routing eliminates the need for exposed exterior conduit runs, improving both the aesthetic appearance and the physical security of the electrical interconnections.

As best shown in FIG. 8, the base structure 110 further comprises forklift pockets 111 formed within or attached to the base frame. The forklift pockets 111 are configured to receive the tines of a standard forklift or pallet jack, enabling the pre-assembled enclosure system 100 to be transported and positioned at the installation site without requiring crane equipment. The forklift pockets 111 are structurally reinforced to support the full weight of the loaded enclosure, including all installed batteries, inverter equipment, and wall assembly components. This transport capability facilitates efficient deployment of the enclosure as a pre-assembled unit manufactured in a controlled factory environment and delivered ready for electrical connection at the installation site.

The enclosure system 100 provides comprehensive fire resistance through the collective properties of the multi-layer wall assembly 140, the insulated partition 104, and the insulated access doors 150. The mineral wool insulation 141 is non-combustible and rated for high-temperature applications, maintaining structural integrity well above the temperatures produced during lithium battery thermal runaway. The fire-resistant fiber cement sheathing 142 and the fire-retardant vapor barrier 143 provide additional fire-containment layers. The insulated partition 104 between the battery compartment and inverter compartment 130 limits fire propagation between compartments. The passive ventilation system, with its direct-to-atmosphere venting path isolated from the wall cavities, ensures that flammable gases produced during a thermal event are expelled from the enclosure rather than accumulating within wall cavities or enclosed spaces. Collectively, these features provide thermal buffering and containment behavior relevant to UL 9540 and UL 9540A compliance requirements for battery energy storage system enclosures.

In a thermal event scenario, the non-combustible multi-layer wall assembly 140 contains heat within the enclosure and protects adjacent structures from thermal radiation. The mineral wool insulation 141 absorbs and retards heat transfer through the wall, providing additional time for emergency response. The fire-retardant vapor barrier 143 activates its fire-retardant compounds when exposed to elevated temperatures, providing a chemical suppression effect at the sheathing layer. The fiber cement siding 145 maintains its structural integrity under fire exposure, preventing breach of the exterior cladding. This multi-layered, passive fire-containment approach provides containment for a rated period without reliance on active chemical fire suppression systems, which can be more reliable in remote or unmonitored residential installations where automated suppression systems may fail to activate or may not be serviced regularly. The passive fire containment provided by the non-combustible wall assembly is a significant improvement over single-wall steel enclosures that offer minimal fire resistance and can transmit dangerous levels of heat to adjacent structures during a thermal event.

The exterior fiber cement siding 145 of the multi-layer wall assembly 140 provides the enclosure system 100 with a residential-grade exterior appearance that is visually compatible with the architectural materials and finishes used on residential structures. The fiber cement siding 145 may be painted or factory-finished to match or complement adjacent building exteriors, and the concealed conduit routing within the base structure 110 eliminates exposed wiring and junction boxes that would otherwise signal an industrial installation. The combination of the residential-grade exterior finish and the comprehensive fire-containment capability of the multi-layer wall assembly 140 enables the enclosure system 100 to be installed in close proximity to, or directly adjacent to, occupied structures without the extensive separation distances typically mandated for battery energy storage systems housed in conventional single-wall metallic enclosures. This potential for reduced-clearance or zero-clearance installation substantially expands the available installation locations on residential lots where space is constrained, addressing a significant deployment barrier for distributed energy storage.

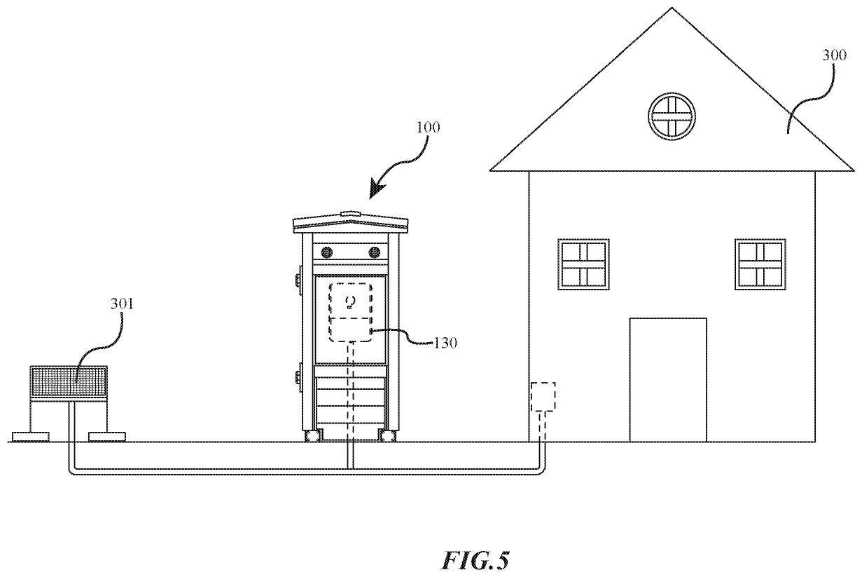

Referring to FIG. 5, the enclosure system 100 is shown in a representative site installation in relation to a building 300 and a solar panel array 301. The enclosure system 100 is positioned adjacent to the building 300 on a concrete pad foundation, with buried wiring connections extending between the enclosure and the building 300 for power distribution and between the enclosure and the solar panel array 301 for renewable energy charging. The concealed conduit routing within the base structure 110 connects to underground conduit runs, enabling all electrical interconnections to be hidden from view. The inverter compartment 130 houses power conversion equipment that interfaces with both the battery storage and the building electrical system, providing bidirectional power flow for charging from solar or grid sources and discharging to serve building loads or export to the utility grid.

The enclosure system 100 is configured for integration with various external power sources. Solar photovoltaic integration is provided through dedicated connection points configured for standard photovoltaic system outputs, including DC disconnect switches and surge protection devices. Building power integration includes a main disconnect and transfer switch arrangement enabling seamless transition between power sources. For installations incorporating hydroelectric or other renewable generation sources, additional connection points with appropriate power conditioning equipment are provided. The power conversion equipment within the inverter compartment 130 accommodates various input voltage ranges and provides output power quality suitable for residential and commercial applications.

The enclosure system 100 in a preferred embodiment includes a comprehensive battery management system that monitors individual battery status, charging cycles, and temperature conditions. The battery management system includes cell balancing capabilities, state-of-charge monitoring, and fault detection circuits. The system provides real-time data logging and can initiate protective measures including power disconnection if battery parameters exceed predetermined limits. An emergency disconnect system enables rapid power isolation from outside the enclosure, with both manual and automated activation capabilities and visual status indicators.

The enclosure system 100 is designed for factory pre-assembly and delivery as a substantially complete unit. The assembly sequence begins with fabrication of the welded steel frame, followed by installation of the insulated partition 104, the multi-layer wall assembly 140 layers (insulation 141, sheathing 142, vapor barrier 143, furring strips 144, and siding 145), the roof assembly 101, the base structure 110 with forklift pockets 111, and the battery rack system 120. Environmental control components including the heater 105 and thermostat-controlled fans 103 are installed and tested prior to shipment. The pre-assembled enclosure is transported to the installation site on a standard semi-trailer, positioned using a forklift engaging the forklift pockets 111, and secured to the prepared concrete pad foundation. Electrical connections between the enclosure and the building and power sources are completed through the base-integrated conduit routing area in the base structure 110, and batteries are installed on the rack system 120.

The compartmentalized design of the enclosure system 100 facilitates maintenance access. The battery compartment is serviced through the access doors 150, with the battery rack system 120 enabling individual battery units to be slid out on rails after disconnecting power cables. The inverter compartment 130 is serviced through its separate access door without requiring access to the battery compartment. The heater 105 and thermostat-controlled fans 103 are accessible through the battery compartment doors and are modular for individual replacement. Electrical connections in the base conduit routing area are accessible through removable panels in the base structure 110.

The electrical system of the enclosure system 100 incorporates concealed conduit routing through the base structure 110 that channels all power and control wiring through hidden pathways while maintaining appropriate separation between power and control circuits. Wiring specifications meet or exceed relevant electrical codes and UL requirements. Ground fault protection includes a comprehensive grounding system connecting all metallic components to a common ground point, with ground fault circuit interrupters at appropriate locations. The power conversion system within the inverter compartment 130 utilizes high-efficiency inverter technology with power factor correction, harmonic filtering, and output voltage regulation.

While various modifications and alternative forms of the invention are contemplated, specific examples have been shown by way of example in the drawings and are described in detail herein. It should be understood, however, that the invention is not limited to the particular forms disclosed. Rather, the invention encompasses all modifications, equivalents, and alternatives falling within the spirit and scope of the invention as defined by the following appended claims. For example, the multi-layer wall assembly may employ insulation materials other than mineral wool, including ceramic fiber or aerogel blankets, provided the insulation is non-combustible and provides adequate thermal resistance. The exterior cladding may comprise materials other than fiber cement, including metal panels or composite cladding, provided the material meets applicable fire resistance requirements. The battery rack system may be configured for battery form factors other than standard 19-inch rack-mount units. The enclosure dimensions may be scaled upward or downward to accommodate different storage capacities.

The foregoing detailed description has been presented for purposes of illustration and description. It is not intended to be exhaustive or to limit the invention to the precise forms disclosed. Many modifications and variations are possible in light of the above teaching. The described embodiments were chosen to best explain the principles of the invention and its practical application, thereby enabling others skilled in the art to utilize the invention in various embodiments and with various modifications as are suited to the particular use contemplated. The scope of the invention is indicated by the appended claims rather than the foregoing description.

What is claimed is:

1. An outdoor energy storage enclosure system comprising:
a structural housing defining an interior volume, the structural housing having an overall height of less than 96 inches;
a multi-layer wall assembly forming at least a substantial portion of exterior walls of the structural housing, the multi-layer wall assembly comprising at least an insulation layer disposed between structural members of the structural housing, a fire-resistant sheathing layer outboard of the insulation layer, a fire-retardant vapor barrier applied to the fire-resistant sheathing layer, a plurality of furring strips outboard of the fire-retardant vapor barrier defining a rainscreen drainage and ventilation gap, and an exterior cladding layer attached to the plurality of furring strips;
a battery compartment disposed within the interior volume and configured to receive one or more energy storage units;
an inverter compartment disposed within the interior volume and physically separated from the battery compartment by an insulated partition, the insulated partition preventing airflow between the battery compartment and the inverter compartment;
a roof assembly disposed atop the structural housing, the roof assembly comprising a vented air gap defined between an outer roof surface and an underlying roof structure; and
a passive ventilation system comprising at least one intake opening positioned at a lower portion of the battery compartment and at least one exhaust opening positioned at an upper portion of the battery compartment, the passive ventilation system providing direct-to-atmosphere gas venting through a ventilation path that is isolated from wall cavities of the multi-layer wall assembly.

2. The outdoor energy storage enclosure system of claim 1, wherein the insulation layer comprises mineral wool insulation that is non-combustible and has a melting point exceeding 2,000 degrees Fahrenheit.

3. The outdoor energy storage enclosure system of claim 1, wherein the fire-resistant sheathing layer and the exterior cladding layer each comprise fiber cement.

4. The outdoor energy storage enclosure system of claim 1, wherein the rainscreen drainage and ventilation gap and the vented air gap of the roof assembly cooperatively form a dual-convective thermal dissipation system in which ambient air convects through both the rainscreen drainage and ventilation gap along the multi-layer wall assembly and through the vented air gap along the roof assembly, dissipating solar heat absorbed by the exterior cladding layer and the outer roof surface before the solar heat conducts through the insulation layer to the battery compartment.

5. The outdoor energy storage enclosure system of claim 1, wherein the battery compartment is configured to house indoor-rated battery units in an outdoor environment, the multi-layer wall assembly and the vented air gap maintaining temperature, humidity, and fire-protection conditions within the battery compartment that are suitable for indoor-rated battery equipment.

6. The outdoor energy storage enclosure system of claim 1, wherein the battery compartment is divided into upper and lower sub-compartments, each sub-compartment having a separate insulated access door comprising mineral wool insulation between metal panels and intumescent seals around a door perimeter.

7. The outdoor energy storage enclosure system of claim 1, wherein the battery compartment comprises a server rack rail system configured to slidably support a plurality of standard 19-inch rack-mount battery units.

8. The outdoor energy storage enclosure system of claim 1, further comprising a base structure supporting the structural housing, the base structure comprising an integrated conduit routing area disposed beneath the battery compartment and the inverter compartment and configured to receive electrical conductors in concealed pathways, and forklift pockets configured to receive tines of a forklift for transport and placement of the enclosure system.

9. The outdoor energy storage enclosure system of claim 1, further comprising a heater disposed within the battery compartment and at least one thermostat-controlled fan associated with the battery compartment, the heater and the at least one thermostat-controlled fan configured as supplemental thermal management systems that operate when passive thermal regulation by the multi-layer wall assembly and the vented air gap is insufficient to maintain a target temperature range within the battery compartment.

10. The outdoor energy storage enclosure system of claim 1, wherein the inverter compartment comprises a metal exterior frame construction configured to dissipate inverter waste heat by thermal conduction through the frame to the exterior of the enclosure system.

11. The outdoor energy storage enclosure system of claim 1, wherein the multi-layer wall assembly provides passive fire containment for the battery compartment during a battery thermal runaway event without reliance on active chemical fire suppression, the insulation layer, the fire-resistant sheathing layer, the fire-retardant vapor barrier, and the exterior cladding layer each being non-combustible.

12. A method of providing thermally managed outdoor energy storage, the method comprising:
providing an outdoor enclosure comprising a multi-layer wall assembly having at least an insulation layer, a fire-resistant sheathing layer, a fire-retardant vapor barrier, a rainscreen drainage and ventilation gap defined by a plurality of furring strips, and an exterior cladding layer;
housing one or more energy storage units within a battery compartment of the outdoor enclosure;
physically isolating the battery compartment from an inverter compartment within the outdoor enclosure using an insulated partition that prevents airflow between the battery compartment and the inverter compartment;
passively reducing solar heat gain into the battery compartment through a vented air gap in a roof assembly of the outdoor enclosure, the vented air gap disposed between an outer roof surface and an underlying roof structure;
passively dissipating solar heat absorbed by the exterior cladding layer through convective airflow within the rainscreen drainage and ventilation gap prior to conduction of the solar heat through the insulation layer to the battery compartment; and
venting gases from the battery compartment directly to the exterior atmosphere through a passive ventilation path that is isolated from wall cavities of the multi-layer wall assembly.

13. The method of claim 12, further comprising maintaining a target temperature of approximately 77 degrees Fahrenheit within the battery compartment primarily through passive thermal buffering provided by the multi-layer wall assembly and the vented air gap, and supplementally through a heater activated when an internal temperature falls below a predetermined lower threshold and at least one thermostat-controlled fan activated when the internal temperature exceeds a predetermined upper threshold.

14. The method of claim 12, further comprising housing indoor-rated battery units within the battery compartment in the outdoor environment, the multi-layer wall assembly and the vented air gap maintaining environmental conditions within the battery compartment that are suitable for indoor-rated battery equipment.

15. The method of claim 12, further comprising routing electrical conductors through an integrated conduit routing area disposed within a base structure of the outdoor enclosure beneath the battery compartment and the inverter compartment.

16. The method of claim 12, wherein the insulation layer comprises mineral wool and the fire-resistant sheathing layer and the exterior cladding layer each comprise fiber cement, providing a non-combustible wall assembly through its full depth.

17. An outdoor energy storage enclosure system comprising:
a welded structural frame defining an interior volume, the structural frame having an overall height of less than 96 inches;
a multi-layer wall assembly attached to the structural frame, the multi-layer wall assembly comprising, in order from an interior side to an exterior side: mineral wool insulation disposed between structural members of the structural frame; a fiber cement sheathing layer attached to the structural members; a fire-retardant vapor barrier applied to the fiber cement sheathing layer; a plurality of fiber cement furring strips attached to the fiber cement sheathing layer and defining a rainscreen drainage and ventilation gap; and fiber cement siding attached to the plurality of fiber cement furring strips;
a battery compartment within the interior volume divided into upper and lower sub-compartments, each sub-compartment comprising a server rack rail system configured to slidably support a plurality of rack-mount battery units, and each sub-compartment having a separate insulated access door;
an inverter compartment within the interior volume, physically separated from the battery compartment by an insulated partition that prevents airflow between the battery compartment and the inverter compartment;
a roof assembly comprising an outer roof surface spaced apart from an inner roof structure to define a vented air gap therebetween;
a passive ventilation system comprising at least one intake opening at a lower portion of the battery compartment and at least one exhaust opening at an upper portion of the battery compartment, the passive ventilation system providing direct-to-atmosphere gas venting through a ventilation path isolated from wall cavities of the multi-layer wall assembly;
a base structure supporting the structural frame, the base structure comprising an integrated conduit routing area configured to receive electrical conductors in concealed pathways beneath the battery compartment and the inverter compartment, and forklift pockets configured to receive tines of a forklift for transport and placement of the enclosure system; and
a supplemental thermal management system comprising a heater disposed within the battery compartment and at least one thermostat-controlled fan associated with the battery compartment, the heater and the at least one thermostat-controlled fan configured to operate as supplemental thermal management when passive thermal regulation by the multi-layer wall assembly and the vented air gap is insufficient to maintain a target temperature range within the battery compartment.

18. The outdoor energy storage enclosure system of claim 17, wherein the rainscreen drainage and ventilation gap and the vented air gap cooperatively form a dual-convective thermal dissipation system that dissipates solar heat absorbed by the fiber cement siding and the outer roof surface before the solar heat conducts through the mineral wool insulation to the battery compartment.

19. The outdoor energy storage enclosure system of claim 17, wherein the battery compartment is configured to maintain environmental conditions suitable for housing indoor-rated, standard 19-inch rack-mount battery units in an outdoor setting.

20. The outdoor energy storage enclosure system of claim 17, wherein the insulated access doors each comprise mineral wool insulation between metal panels and intumescent seals around a door perimeter, and wherein the multi-layer wall assembly provides passive fire containment for the battery compartment without reliance on active chemical fire suppression.
